(19) United States
(12) Patent Application Publication
(10) Pub. No.: US 2010/0044172 A1
(43) Pub. Date: Feb. 25, 2010

(54) DAMPING FORCE VARIABLE VALVE OF SHOCK ABSORBER

(75) Inventors: Young Whan Jee, Gyeonggi-do (KR); Kyu Shik Park, Seoul (KR)

Correspondence Address: SEED INTELLECTUAL PROPERTY LAW GROUP PLLC, 701 FIFTH AVE, SUITE 5400, SEATTLE, WA, 98104, US

(73) Assignee: Mando Corporation, Gyeonggi-do (KR)

(21) Appl. No.: 12/544,793

(22) Filed: Aug. 20, 2009

(30) Foreign Application Priority Data
Aug. 21, 2008 (KR) 10-2008-0081656

(51) Int. Cl. F16F 9/34

(52) U.S. Cl. 188/266.5; 188/322.13

(57) ABSTRACT

A damping force variable valve includes a retainer including a main body connected at a central region thereof to a high pressure region of a shock absorber cylinder, the main body having an outer diameter increased outwards, and a spool rod formed integrally with the main body to extend from the central region, the spool rod having a hollow portion formed at a central portion thereof to allow a spool to be inserted in the hollow portion, a solenoid coupled to a lower side of the retainer, and a spool pressurizing installed in the solenoid and configured to move in response to electrical power applied to the solenoid to pressurize the spool.

### CROSS REFERENCE TO RELATED APPLICATION

This application claims priority from and the benefit of Korean Patent Application No. 10-2008-0081656, filed on Aug. 21, 2008, which is hereby incorporated by reference for all purposes as if fully set forth herein.

### BACKGROUND

1. Technical Field

The present disclosure relates to a damping force variable valve, and more particularly, to a damping force variable valve of a shock absorber having an improved structure for press-fitting and coupling a pressurizing rod of a solenoid part and a simplified structure of a flow passage formed therein.

2. Description of Related Art

In general, a shock absorber is a device for absorbing sudden impact or vibration and is employed in a vehicle to rapidly absorb vibration of a spring generated by a road surface when the vehicle is driven and thus to secure handling stability and provide ride comfort.

The shock absorber lowers damping force when a vehicle is driven under a normal condition to absorb vibration caused by irregularities of a road surface and to enhance the ride comfort. Also, when the vehicle turns, accelerates, decelerates and/or is driven at high-speed, the shock absorber increases damping force to restrain a posture of a vehicle body from being changed, whereby the handling stability of the vehicle can be enhanced.

In recent, in the meantime, a damping force variable valve capable of adjusting appropriately a characteristic of damping force is provided on one side of the shock absorber, so that the shock absorber has been developed into a damping force variable type shock absorber which can adjust a characteristic of damping force appropriately according to a condition of a road surface and a driving status of a vehicle in order to enhance the ride comfort or handling stability of the vehicle.

To this end, a damping force variable shock absorber has a damping force variable valve for varying damping force provided at one side of a base shell.

FIG. 1 is a cross-sectional view of a damping force variable valve according to a prior art, wherein a damping force variable valve 10 is configured such that a spool 30 operates in a poppet valve manner with respect to a spool rod 20 to control fluid communication. As shown in FIG. 1, the conventional damping force variable valve 10 includes a solenoid part 40, the spool rod 20, the spool 30, a lower retainer 22, a main disk 26 and an upper retainer 24.

A plug 21 is installed at an upper end of the spool rod 20, and a coil spring 21a is embedded between the plug 21 and the spool 30 to bring the spool 30 into close contact with the solenoid part 40. In addition, a plurality of connecting ports 20a, 20b and 20c through which fluid flows are formed in the spool rod 20 to pass therethrough.

The lower retainer 22 is provided on an outer circumferential surface of the spool rod 20, and an inflow passage 22a, a discharge passage 22b and a detour passage 22c are formed in the lower retainer to pass therethrough.

Also, the main disk 26 is disposed such that it covers the inflow passage 22a at a rear side of the upper retainer 22, so that working oil passing through the inflow passage 22a directly strikes the main disk to thereby generate damping force.

In addition, the upper retainer 24 is provided at an upper side of the lower retainer 22 to form a guide flow passage through which a high pressure chamber of the shock absorber fluid communicates with an interior of the lower retainer 22, and a nut 28 for securing the lower retainer 22 is installed on an outer circumferential surface of an upper end of the spool rod 20.

The solenoid part 40 has an upper end fixedly installed to a lower end of a valve housing 12 to be coupled an outside of the shock absorber, and a bobbin 42 with a coil wound therearound and the pressurizing rod 44 which vertically moves in response to a variation of current supplied to a coil wound around the bobbin 42 are provided in the driving block 46. The solenoid part 40 so configured is finished by a cover part 48 coupled to a lower side thereof.

A guide part 49 is provided in the cover part 48 to elastically support a spring 53 provided between the plunger 50 and the cover part and to guide the movement of the pressurizing rod 44. In addition, a bushing 54 made of copper (Cu) is provided between the pressurizing rod 44 and the guide part 48 to thereby reduce friction generated when the pressurizing rod 44 moves.

In the meantime, the pressurizing rod 44 is press-fitted into and fixed to the plunger 50 which is perforated at its central portion. The plunger 50 may be formed of a permanent magnet. In addition, if voltage is applied to the solenoid part 40, magnetic force is generated in the coil wound around the bobbin 42, and the plunger 50 moves upward and downward by this magnetic force. Accordingly, the pressurizing rod 44 moves together with the plunger 50 to move the spool 30.

A hollow flow passage 32 is formed in the spool 30, and the hollow flow passage 32 is led in a lateral direction at its upper side adjacent to the pressurizing rod 44. In addition, a flow passage 51 is formed on an outer circumference surface of the plunger 50. Accordingly, when the plunger 50 moves, working oil partially flows through the hollow flow passage 32 of the spool 30 and the flow passage 51 to compensate a pressure difference caused by the movement of the plunger 50.

In the damping force variable valve 10 according to the prior art, however, the pressurizing rod 44 may be deformed when the pressurizing rod 44 is press-fitted into and fixed to the plunger 50. In addition, if the pressurizing rod 44 is not coupled to the plunger 50 perpendicularly, hysteresis in which a change in magnetization is delayed by a change in external magnetic field may be generated, and this hysteresis may prevent the spool 30 from smoothly moving. Also, in the conventional damping force variable valve 10, a difference in back pressure may be generated between the flow passages respectively formed in the spool 30 and the plunger 50, so that this difference in back pressure may cause vibration when the spool 30 moves. As described above, if the vibration is generated when the spool 30 moves, the frictional resistance is increased and the smooth movement of the spool is disturbed, so that characteristics of the damping force may be deteriorated.

### BRIEF SUMMARY

In one embodiment, a damping force variable valve includes a pressurizing rod and a plunger integrally formed to allow the pressurizing rod and the plunger to cooperate with each other by applying electrical power, such as voltage to a solenoid part. Furthermore, a flow passage formed in the valve is simplified to enhance the movability of a spool.

A damping force variable valve according to one embodiment is installed to a shock absorber, which includes a cylinder and a reservoir chamber communicating with the cylinder and is formed with a high pressure part connected to a rebound chamber of the cylinder and a low pressure part connected to the reservoir chamber. The damping force variable valve includes a retainer including a main body connected at a central region thereof to the high pressure part, the main body having an outer diameter increased outwards, and a spool rod part formed integrally with the main body to extend from the central region of the main body, the spool rod part having a hollow portion formed at a central portion thereof to allow a spool to be inserted in the hollow portion; a solenoid part coupled to a lower side of the retainer; and a spool pressurizing part installed in the solenoid part and moving in response to voltage applied to the solenoid to pressurize the spool.

In one aspect, the spool pressurizing part may have a cylindrical shape and includes a protuberance formed at a central portion thereof so that the protuberance is partially inserted into the hollow portion of the spool rod part and is in contact with the spool. Further, the spool may have a hollow flow passage formed therein to pass through a central portion thereof, and the spool pressurizing part has a flow passage formed in a central portion thereof and communicates with the hollow flow passage. In addition, the spool pressurizing part is preferably formed in a single body by a sintering process. Furthermore, the spool rod part may be surface-treated to form a hatching pattern on an inner circumference surface thereof.

### BRIEF DESCRIPTION OF THE SEVERAL VIEWS OF THE DRAWINGS

FIG. 1 is a cross-sectional view of a damping force variable valve according to a prior art;

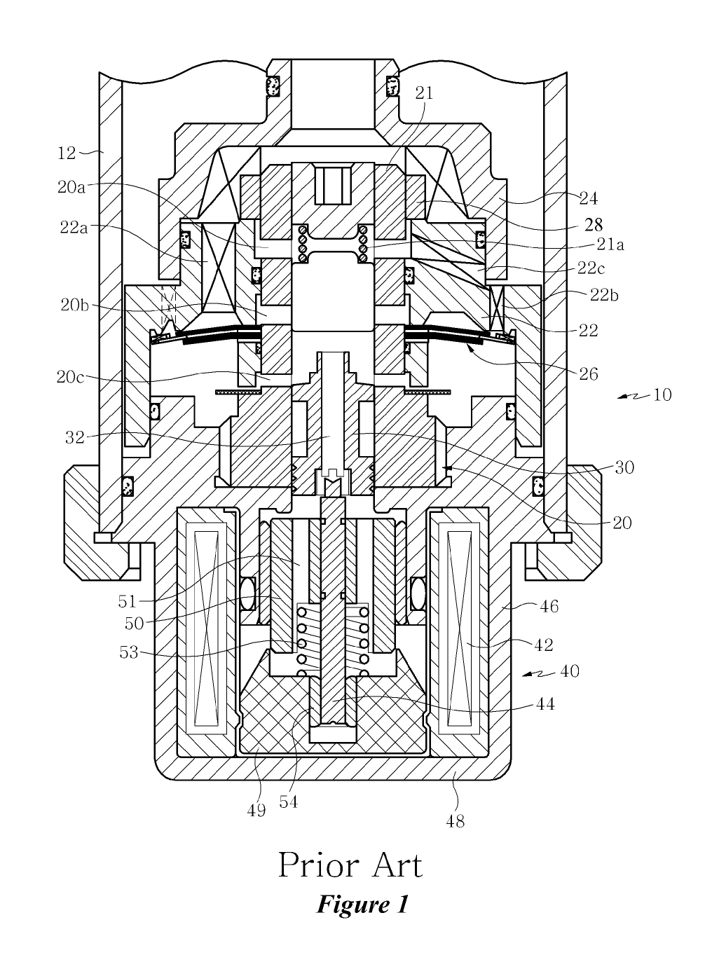

FIG. 2 is a cross-sectional view of a damping force variable valve according to one embodiment; and

FIG. 3 is a cross-sectional view of a shock absorber including a damping force variable valve according to one embodiment.

### DETAILED DESCRIPTION

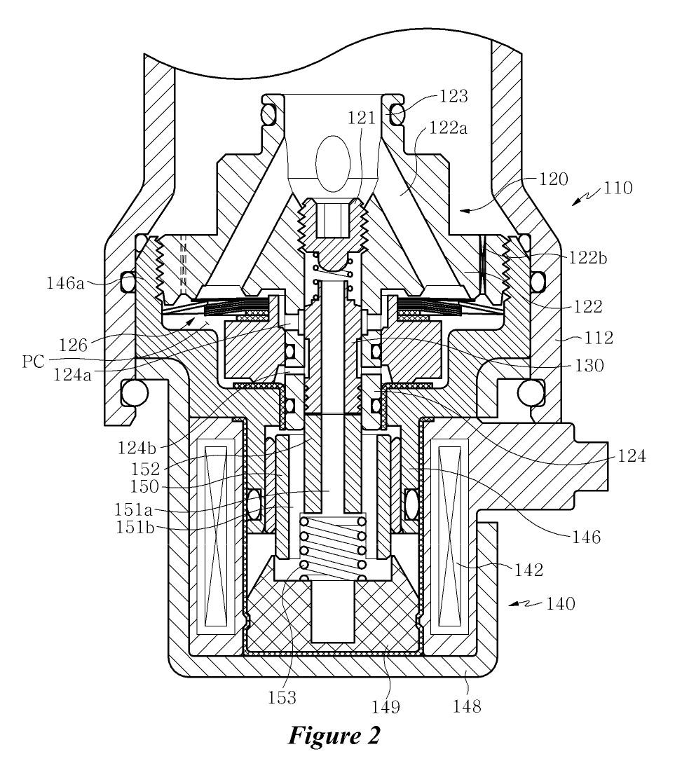

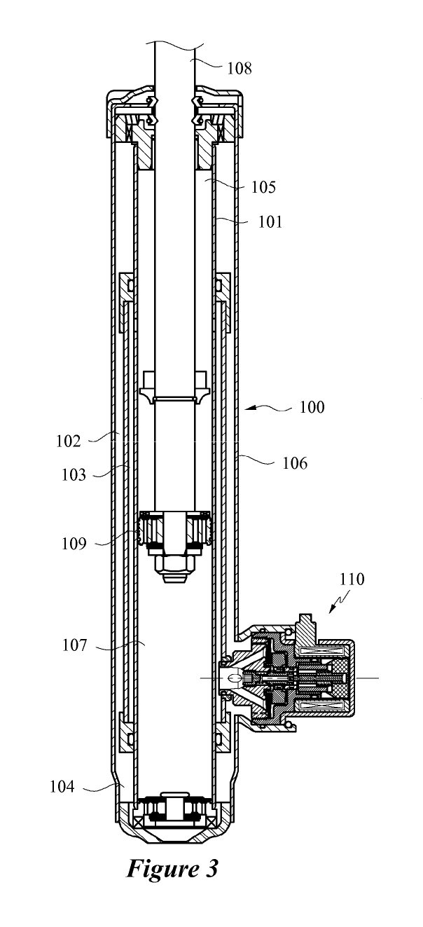

Hereinafter, example embodiments will be described in detail with reference to the accompanying drawings in FIGS. 2 and 3.

FIG. 2 is a cross-sectional view of a damping force variable valve according to one embodiment. FIG. 3 illustrates a cross-sectional view of a shock absorber including the damping force variable valve according to one embodiment.

As shown in FIG. 3, a damping force variable valve 110 according to one embodiment can be incorporated in a shock absorber 100 that includes a cylinder 101, a reservoir chamber 102 communicating with the cylinder 101, a high pressure part 103 connected to a rebound chamber 105 of the cylinder 101, and a low pressure part 104 connected to the reservoir chamber 102. The shock absorber 100 can include a base shell 106, a piston rod 108 having one end in the cylinder 101 which is coupled to a piston valve 109, forming a compression chamber 107 in the cylinder 101.

Referring to FIG. 2, a damping force variable valve 110 according to one embodiment is installed to the shock absorber 100, which includes the cylinder 101 and the reservoir chamber 102 communicating with the cylinder 101 and is formed with the high pressure part 103 connected to the rebound chamber 105 of the cylinder 101 and the low pressure part connected to the reservoir chamber 102.

Such a damping force variable valve 110 includes a retainer 120 installed in a valve housing 112 and a main disk 126, and a solenoid part 140 is coupled to a lower side of the valve housing 112.

The retainer 120 includes a main body 122 and a spool rod part 124 formed integrally with the main body 122.

The main body 122 is configured to be connected to the high pressure part 103 at a central portion thereof and is formed to have an outer diameter increased outwards. To this end, in the retainer 120, a connecting port 123 connected to the high pressure part 103 of the shock absorber 100 is formed toward an end of the main body 122, toward which the damping force variable valve 110 is coupled to the shock absorber 100.

In one aspect, an inflow passage 122a connected to the connecting port 123 is formed in the main body 122 to pass therethrough. The inflow passage 122a is inclined outward to conform to a shape of the main body 122, so that working fluid, such as oil, that has passed through the inflow passage 122a is discharged to a low side of the retainer 120.

In one aspect, the spool rod part 124 is formed integrally with the main body 122 to extend from a lower central region thereof. A hollow portion into which a spool 130 is inserted is formed at a central portion of the spool rod part 124. In addition, the spool rod part 124 is formed with a plurality of connecting ports 124a and 124b through which fluid passes. Among the plurality of connecting ports, the connecting port 124a formed toward an upper side guides the working fluid, which is introduced from the inflow passage 122a, to an inside of the spool rod part 124. The working fluid is supplied to a back-pressure chamber PC through the connecting port 124b formed toward a lower side among the plurality of connecting ports, and pressure for opening/closing the main disk 126 is controlled by the working fluid introduced into the back pressure chamber PC.

In a state where the spool 130 is inserted in the hollow portion, a spring 121a for elastically supporting the spool 130 is mounted to the spool rod part 124 and a plug 121 is coupled to an upper side thereof.

The main disk 126 is disposed to cover the inflow passage 122a at a rear of the retainer 120, so that the main disk 126 is directly struck by the working fluid passing through the inflow passage 122a to thereby generate damping force. The main disk 126 stands against the working fluid flowing in the inflow passage 122a and then is leaned backward to allow the working fluid to flow toward a discharging passage 122b.

In one aspect, an internal slit is formed on an internal side of the main disk 126 to allow a portion of the working fluid passing through the inflow passage 122a to flow in a direction other than the discharge passage 122b. The internal slit always communicates with the connecting port of the spool 130. In one aspect, an external slit is formed on an external side of the main disk 126. This external slit communicates with the discharge passage 122b. The discharge passage 122b is formed on the retainer 120 to allow fluid, which leans the main disk 126 backward according to the pressure in the back pressure chamber PC and is then supplied, to be discharged to the low pressure part 104 (FIG. 3).

In one aspect, the solenoid part 140 has an upper end detachably coupled to a lower end of the valve housing 112, which in turn is configured to be coupled to an outside of the shock absorber 100 (FIG. 3). Also, the solenoid part 140 includes a bobbin 142, around which a coil is wound to generate magnetic force according to a change in current, and a spool pressurizing part or plunger 150 which is installed to be movable in response to a change in an electrical power, such as current supplied to the coil wound around the bobbin.

Also, a driving block 146 is provided at an upper side of the solenoid part 140 to guide the spool pressurizing part 150 and finish the upper side of the solenoid part 140. An outer circumference of the driving block 146 extends upward to form an expansion part 146a. Further, a cover part 148 is coupled to a lower end of the solenoid part 140. In addition, the retainer 120 is coupled to the expansion part 146a of the driving block 146 to maintain the fixed state of the retainer 120.

In one aspect, the spool pressurizing part 150 has a cylindrical shape. In one aspect, a protuberance 152 is formed at a central portion of the spool pressurizing part 150 to be in contact with the spool 130. The protuberance 152 is partially inserted into the hollow portion of the spool rod part 124. The protuberance 152 is moved together with the spool pressurizing part 150 by the electrical power or current applied to the solenoid part 140, and thus, the spool 130 is moved in response to the movement of the spool pressurizing part 152.

The spool 130 has a hollow flow passage 132 passing through a central portion thereof. Accordingly, the working fluid flows by a pressure difference generated when the spool 130 is moved, thereby counterbalancing a pressure difference.

In one aspect, the spool pressurizing part 150 is formed with a first flow passage 151a, which passes through a central portion of the protuberance 152 and communicates with the hollow flow passage 132, and a second flow passage 151b formed on an outer circumference of the protuberance 152. Therefore, the working fluid passing through the spool 130 is discharged to the first and second flow passages 151a and 151b of the spool pressurizing part 150 and counterbalances a difference in back pressure caused by the movement of the spool pressurizing part 150. Accordingly, when the spool pressurizing part 150 is moved, vibrations are scarcely generated and the spool 130 which is in contact therewith can move without vibration.

In one aspect, a guide part 149 is provided inside of the cover part 148 to support a spring 153 provided between the cover part and the spool pressurizing part 150 and guide the movement of the spool pressurizing part 150.

According to one embodiment, the spool pressurizing part 150 is formed in a single body by a sintering process. The spool pressurizing part 150 formed by a sintering process may have a plurality of voids formed therein so that oil may be contained in the voids. Accordingly, the frictional resistance between the spool pressurizing part 150 and the spool rod part can be damped when the spool pressurizing part moves.

In addition, the spool rod part 124 may be surface-treated such that a hatching pattern is formed on an inner circumference surface of the spool rod part 124. Preferably, a cross hatching pattern is formed on the spool rod part 124, and accordingly, it is possible to reduce a contact area between the spool rod part 124 and the spool pressurizing part 150 and to reduce the frictional resistance generated when the spool pressurizing part 150 moves.

In a damping force variable valve according to an embodiment of the present invention, since the spool is pressurized by the spool pressurizing part in which the protuberance is formed integrally with the plunger, the deformation of the plunger caused by a machining process such as a press-fit process can be prevented. Accordingly, it is possible to prevent the hysteresis in which a change in magnetization is delayed by a change in external magnetic field from being generated. In addition, a structure of the flow passages formed in the spool and the spool pressurizing part is simplified to minimize the generation of back pressure when the spool moves, and it is possible to prevent vibration from being generated when the spool moves. Also, the plunger and the pressurizing rod, which are provided as separate members in a prior art, are integrally formed to reduce the number of required parts and to enhance ease of assembly and thus productivity. In addition, the hatching pattern is formed on the spool rod part, so that the frictional resistance between the spool rod part and the spool pressurizing part can be reduced. Accordingly, there is an advantage in that there is no need to provide a conventional bushing used to reduce the friction of the pressurizing rod.

Although the damping force variable valve according to some embodiments of the present invention has been described with reference to the accompanying drawings in FIGS. 2 and 3, the present invention does not limited to the aforementioned embodiment and the accompanying drawings. It will be apparent that those skilled in the art can make various modifications and changes thereto within the scope of the invention defined by the claims.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A damping force variable valve configured to be coupled to a shock absorber, the damping force variable valve comprising:
a retainer including a main body having an outer peripheral region including a diameter increasing in a direction away from the shock absorber;
a spool rod formed integrally with the main body to extend from a central region of the main body, the spool rod having a hollow portion formed at a central portion thereof,
a spool inserted in the hollow portion of the spool rod;
a solenoid coupled to a lower side of the retainer; and
a spool pressurizing member installed in the solenoid and configured to move in response to electrical power applied to the solenoid to pressurize the spool.

2. The damping force variable valve of claim 1, wherein the spool pressurizing part has a cylindrical shape and includes a protuberance formed at a central portion thereof, the protuberance partially inserted into the hollow portion of the spool rod and in contact with the spool.

3. The damping force variable valve of claim 1, wherein the spool has a hollow flow passage formed therein to pass through a central portion thereof, and the spool pressurizing part has a flow passage formed in a central portion thereof in fluid communication with the hollow flow passage of the spool.

4. The damping force variable valve of claim 1, wherein the spool pressurizing part is formed in a single body by a sintering process.

5. The damping force variable valve of claim 1, wherein the spool rod is surface-treated to form a hatching pattern on an inner circumference surface thereof.

6. An apparatus, comprising:
a shock absorber having a cylinder, a reservoir chamber in fluid communication with the cylinder, a high-pressure region, a low-pressure region, the cylinder having a rebound chamber in fluid communication with the high-pressure region, and a reservoir chamber in fluid communication with the low-pressure region;
a damping force variable valve main body coupled to the shock absorber and including a connecting port toward a central region of the main body and in fluid communication with the high-pressure region, the main body having a distal end and a proximal end with respect to the shock absorber, the distal end having a larger diameter than the proximal end;
a spool rod having a hollow central region and formed from a unitary body of material with the main body toward the central region of the main body and spaced from the connecting port;
a spool movably positioned in the hollow region of the spool rod;
a solenoid coupled to the main body; and
a spool pressurizing plunger positioned in the solenoid and in contact with the spool, the spool pressurizing plunger configured to move in response to electrical power applied to the solenoid to pressurize the spool.
